(19) United States
(12) Patent Application Publication
(10) Pub. No.: US 2018/0093426 A1
(43) Pub. Date: Apr. 5, 2018

(54) FORMING APPARATUS

(71) Applicant: FUJI XEROX CO., LTD., Tokyo (JP)

(72) Inventor: Naoki HIJI, Kanagawa (JP)

(73) Assignee: FUJI XEROX CO., LTD., Tokyo (JP)

(21) Appl. No.: 15/446,123

(22) Filed: Mar. 1, 2017

(30) Foreign Application Priority Data
Sep. 30, 2016 (JP) 2016-194264

(51) Int. Cl. B29C 67/00

(52) U.S. Cl. CPC B29C 67/0059; B33Y 30/00; B29C 67/0007

(57) ABSTRACT

A forming apparatus includes: multiple color discharge parts that discharge droplets of color forming liquids from nozzles arrayed in a principal scanning direction, the droplets constituting color unit portions when cured; and a transparent discharge part that is provided at a side of the color discharge parts in a sub-scanning direction and that discharges droplets of a transparent forming liquid from nozzles arrayed in the principal scanning direction, the droplets constituting transparent unit portions when cured. A three-dimensional object is formed so as to have a portion in which the color unit portions and the transparent unit portions are periodically stacked.

### CROSS-REFERENCE TO RELATED APPLICATIONS

This application is based on and claims priority under 35 USC 119 from Japanese Patent Application No. 2016-194264 filed Sep. 30, 2016.

### BACKGROUND

### Technical Field

The present invention relates to forming apparatuses.

### SUMMARY

According to an aspect of the present invention, there is provided a forming apparatus including: multiple color discharge parts that discharge droplets of color forming liquids from nozzles arrayed in a principal scanning direction, the droplets constituting color unit portions when cured; and a transparent discharge part that is provided at a side of the color discharge parts in a sub-scanning direction and that discharges droplets of a transparent forming liquid from nozzles arrayed in the principal scanning direction, the droplets constituting transparent unit portions when cured. A three-dimensional object is formed so as to have a portion in which the color unit portions and the transparent unit portions are periodically stacked.

### BRIEF DESCRIPTION OF THE DRAWINGS

Exemplary embodiments of the present invention will be described in detail based on the following figures, wherein:

FIG. 1 is a schematic perspective view of a forming apparatus according to a first exemplary embodiment;

FIG. 2 is a schematic side view of a forming part of the forming apparatus according to the first exemplary embodiment;

FIGS. 3A to 3C are schematic views showing arrangements of unit portions constituting a three-dimensional object that is formed with the forming apparatus according to the first exemplary embodiment, wherein FIG. 3A shows an arrangement of unit portions in two layers before replacement, FIG. 3B shows an arrangement in which upper color unit portions of the upper and lower color unit portions having the same color in FIG. 3A are replaced with transparent unit portions, and FIG. 3C shows an arrangement in which the upper unit portions and the lower unit portions are exchanged such that the discharge parts located on the upstream side in the scanning direction in FIG. 3B discharge the droplets first;

FIG. 4 is a schematic side view of a forming part of a forming apparatus according to a modification of the first exemplary embodiment;

FIGS. 5A to 5C are schematic views showing arrangements of unit portions constituting a three-dimensional object that is formed with the forming apparatus according to the modification of the first exemplary embodiment, wherein FIG. 5A shows an arrangement of unit portions in two layers before replacement, FIG. 5B shows an arrangement in which upper color unit portions, except for white unit portions, of the upper and lower unit portions having the same color in FIG. 5A are replaced with transparent unit portions, and FIG. 5C shows an arrangement in which the upper unit portions and the lower unit portions are exchanged such that the discharge parts located on the upstream side in the scanning direction in FIG. 5B discharge the droplets first;

FIG. 6 is a schematic perspective view of a forming apparatus according to a second exemplary embodiment;

FIG. 7 is a schematic side view of a forming part of the forming apparatus according to the second exemplary embodiment;

FIG. 8 is a schematic bottom view of the forming part of the forming apparatus according to the second exemplary embodiment;

FIGS. 9A to 9D are process diagrams sequentially showing a process of forming a three-dimensional object with the forming apparatus according to the second exemplary embodiment;

FIGS. 10A to 10C are schematic views showing arrangements of unit portions constituting a three-dimensional object that is formed with the forming apparatus according to the second exemplary embodiment, wherein FIG. 10A is a sectional view taken along line XA-XA in FIG. 10C, FIG. 10B is a sectional view taken along line XB-XB in FIG. 10C, and FIG. 10C is a sectional view of the three-dimensional object, taken in Y direction, i.e., the principal scanning direction;

FIG. 11 is a schematic bottom view of a forming part of a forming apparatus according to a modification of the second exemplary embodiment;

FIGS. 12A to 12C are schematic views showing arrangements of unit portions constituting a three-dimensional object that is formed with the forming apparatus according to the modification of the second exemplary embodiment, wherein FIG. 12A is a sectional view taken along line XIIA-XIIA in FIG. 12C, FIG. 12B is a sectional view taken along line XIIB-XIIB in FIG. 12C, and FIG. 12C is a sectional view of the three-dimensional object, taken in Y direction, i.e., the principal scanning direction;

FIG. 13 is a schematic side view of a forming part of a forming apparatus according to a third exemplary embodiment;

FIG. 14 is a schematic bottom view of the forming part of the forming apparatus according to the third exemplary embodiment;

FIGS. 15A to 15E are schematic views showing arrangements of unit portions constituting a three-dimensional object that is formed with the forming apparatus according to the third exemplary embodiment, wherein FIG. 15A shows an arrangement of unit portions in four layers before replacement, FIG. 15B shows an arrangement in which upper color unit portions of the upper and lower color unit portions having the same color in FIG. 15A are replaced with transparent unit portions, and in which the upper unit portions and the lower unit portions are exchanged such that the discharge parts located on the upstream side in the scanning direction discharge the droplets first, FIG. 15C is a sectional view taken along line XVC-XVC in FIG. 15B, FIG. 15D is a sectional view taken along line XVD-XVD in FIG. 15B, and FIG. 15E is a sectional view taken along line XVE-XVE in FIG. 15; and

FIG. 16 is a schematic perspective view of a forming apparatus according to a comparative example.

### DETAILED DESCRIPTION

### First Exemplary Embodiment

A forming apparatus according to a first exemplary embodiment of the present invention will be described below.

### Overall Configuration

First, the overall configuration of a forming apparatus 100, which is a so-called three-dimensional printer, will be described. Note that the width direction of the forming apparatus will be referred to as the X direction, the depth direction of the forming apparatus will be referred to as the Y direction, and the height direction of the forming apparatus will be referred to as the Z direction.

The forming apparatus 100 according to this exemplary embodiment forms a three-dimensional object V by repeating discharging of forming liquid and curing by radiation according to three-dimensional form sectional-shape data. When an overhang or a ceiling is formed, a support part that supports the lower part of the overhang or the ceiling is formed. The support part is removed at the end.

The forming apparatus 100 according to this exemplary embodiment forms a color three-dimensional object V by discharging yellow (Y), magenta (M), cyan (C), black (K), and white (W) droplets 10.

Herein, components related to yellow (Y), magenta (M), cyan (C), black (K), and white (W) will be denoted by reference numerals with the suffixes Y, M, C, K, and W, respectively, and components related to the support part will be denoted by reference numerals with the suffix S. The forming apparatus 100 according to this exemplary embodiment has a discharge part for discharging droplets 10T of a transparent (T) forming liquid, and components related to transparent will be denoted by reference numerals with the suffix T.

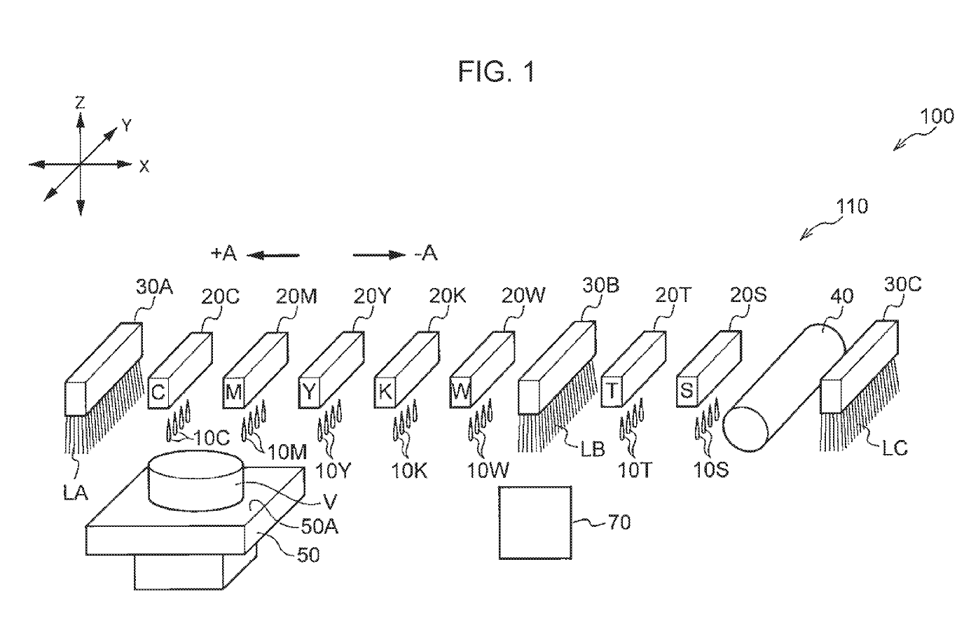

As shown in FIG. 1, the forming apparatus 100 includes a forming part 110, a stage part 50, a controller 70, and the like.

### Forming Part

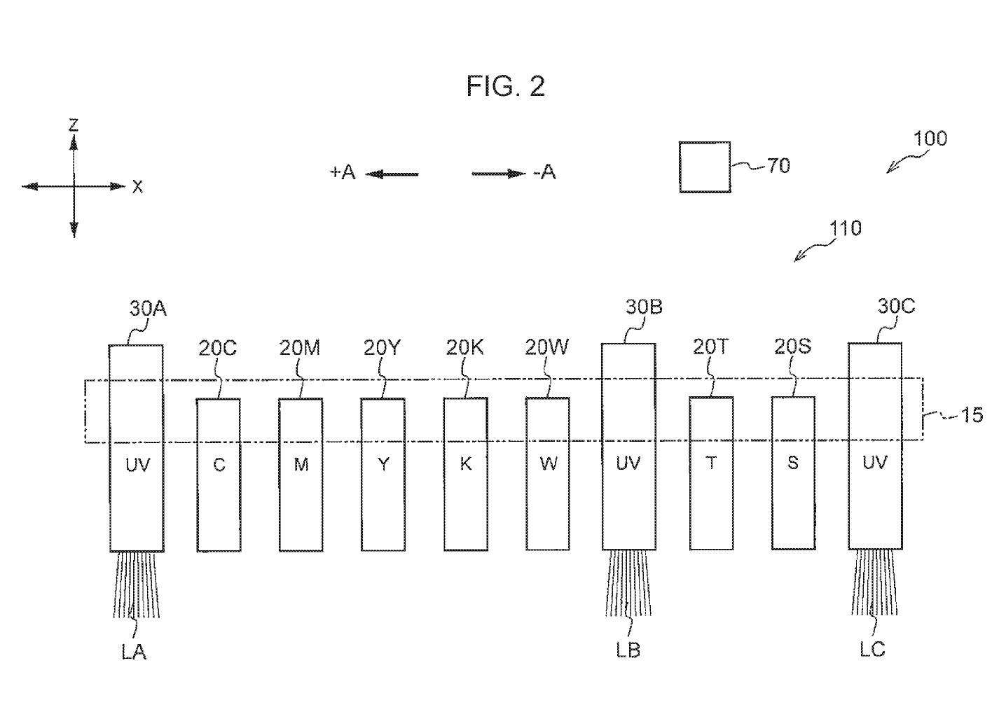

As shown in FIGS. 1 and 2, the forming part 110 includes a discharge part 20C, a discharge part 20M, a discharge part 20Y, a discharge part 20K, a discharge part 20W, a discharge part 20T, and a discharge part 20S that discharge droplets 10C, 10M, 10Y, 10K, 10W, 10T, and 10S of cyan (C), magenta (M), yellow (Y), black (K), white (W), transparent (T), and support-material (S) forming liquids, respectively, toward a base surface 50A of the stage part 50 (see FIG. 1). When they do not need to be distinguished from one another, they will be collectively referred to as the droplets 10 and the discharge parts 20.

The forming part 110 further includes a radiating part 30A, a radiating part 30B, and a radiating part 30C that radiate radiation light LA, LB, and LC, which are ultraviolet rays, onto the base surface 50A of the stage part 50 (see FIG. 1). When they do not need to be distinguished from one another, they will be collectively referred to as the radiation light L and the radiating parts 30.

The forming part 110 further includes a flattening roller 40, serving as an example of a flattening part (see FIG. 1).

The discharge parts 20C, 20M, 20Y, 20K, 20W, 20T, and 20S, the radiating parts 30A, 30B, and 30C, and the flattening roller 40 (see FIG. 1) are integrally held by a retaining member 15 (see FIG. 2).

In each discharge part 20, multiple nozzles (not shown) for discharging droplets are arrayed in the Y direction, i.e., the principal scanning direction. The discharge parts 20C, 20M, 20Y, 20K, 20W, 20T, and 20S are arranged at intervals in the X direction.

The radiating part 30A and the radiating part 30C are disposed on the extreme outer sides in the X direction, and the radiating part 30B is disposed between the discharge part 20W and the discharge part 20T in the X direction.

As shown in FIG. 1, the flattening roller 40 is provided between the discharge part 20S and the radiating part 30C in the X direction.

The flattening roller 40 extends in the Y direction. Although the flattening roller 40 according to this exemplary embodiment is formed of metal, such as SUS, the material thereof is not limited thereto. The flattening roller 40 may be formed of resin or rubber.

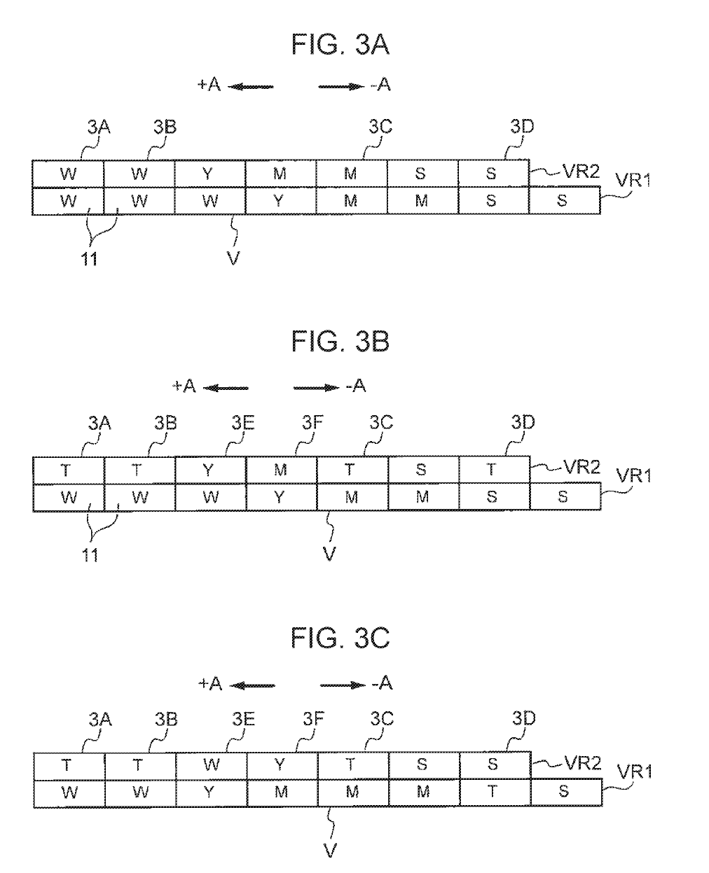

The flattening roller 40 is rotated by a rotation mechanism (not shown) controlled by the controller 70 shown in FIG. 3. The flattening roller 40 is moved up and down in the height direction of the forming apparatus (Z direction), relative to the stage part 50, by an ascending-and-descending mechanism (not shown) controlled by the controller 70.

When flattening the three-dimensional object V, the flattening roller 40 is moved down relative to the retaining member 15 by the ascending-and-descending mechanism. The flattening roller 40 is retracted upward relative to the retaining member 15 by the ascending-and-descending mechanism, when it does not perform flattening. In FIG. 2, illustration of the flattening roller 40 is omitted.

### Stage Part

The top surface of the stage part 50 serves as the base surface 50A, on which the three-dimensional object V is formed. The stage part 50 is moved in the width direction of the forming apparatus (X direction), relative to the forming part 110, and is also moved in the height direction of the forming apparatus (Z direction) by a moving mechanism (not shown).

As described above, because the discharge parts 20, the radiating parts 30, and the flattening roller 40 are held by the retaining member 15 (see FIG. 2), these parts are integrally moved relative to the stage part 50.

### Controller

The controller 70 shown in FIG. 1 has a function of controlling the entire forming apparatus 100.

### Method for Forming Three-Dimensional Object

Next, an example method for forming a three-dimensional object V with the forming apparatus 100 according to this exemplary embodiment will be described. First, the outline of the forming method will be described, and then, the detail of the forming method will be described.

The controller 70 causes the discharge parts 20 to discharge droplets 10 and causes the radiating parts 30 to radiate the radiation light L, while scanning the stage part 50 back and forth in the X direction relative to the forming part 110. After landing, the droplets 10 discharged from the discharge parts 20 are irradiated with the radiation light L emitted from the radiating parts 30 and are cured.

The X direction is a direction in which the forming part 110 is scanned back and forth, and, in the back-and-forth scanning, an outgoing direction of the forming part 110 with respect to the stage part 50 will be referred to as a +A direction, and a returning direction of the forming part 110 with respect to the stage part 50 will be referred to as a −A direction. The principal scanning direction is the Y direction, and the sub-scanning direction is the X direction.

In this manner, the forming apparatus 100 forms the three-dimensional object V (see FIG. 1) on the base surface 50A of the stage part 50 by stacking layers VR (see FIG. 3C), which are formed by curing the forming liquids and a support material by being irradiated with the radiation light L. As will be described below, in this exemplary embodiment, two layers are formed in single scanning (scanning in the +A or −A direction).

Furthermore, a support part is formed from the support material, below a portion in the three-dimensional object V located above a space, so that the three-dimensional object V is formed while the portion above the space is supported with the support part. Finally, the support part is removed from the three-dimensional object V, thus completing the three-dimensional object V having a desired shape.

In this exemplary embodiment, the inside of the three-dimensional object V is formed from white droplets and is be used as the base, and a colored surface is formed on the exterior thereof from color droplets.

Although unevenness is produced on the top surface of the three-dimensional object V during forming due to uneven distribution of droplets or the like, such unevenness is flattened by the flattening roller 40.

Next, the forming method will be described in detail.

Each rectangle with the letter Y, M, C, K, W, T, or S therein shown in FIG. 3 schematically shows a portion formed as a result of one droplet 10 being cured, and this is defined as a “unit portion 11”. The unit portion 11 corresponds to one pixel of data.

When the controller 70 (see FIG. 1) receives data on a three-dimensional object V to be formed from an external device or the like, the controller 70 converts the data on the three-dimensional object V into data on multiple layers VR (see FIG. 3A), that is, two-dimensional data composed of multiple pixels.

Of the unit portions 11 constituting the three-dimensional object V, each unit portions 11 being formed of one drop, those formed of the yellow (Y), magenta (M), cyan (C), black (K), white (W) and support material (S) droplets 10Y, 10M, 10C, 10K, and 10S will be referred to as yellow unit portions 11Y, magenta unit portions 11M, cyan unit portions 11C, black unit portions 11K, white unit portions 11W, and support-material unit portions 11S, respectively, and they may be collectively referred to as “color unit portions 11E”. The unit portions 11 formed of transparent droplets 10T will be referred to as transparent unit portions 11T. The unit portions 11 formed of white (W) droplets 10W may sometimes be distinguished as the white unit portions 11W.

The controller 70 divides the data on the multiple layers VR into pairs of two layers. The lower layer will be referred to as a layer VR1, and the upper layer will be referred to as a layer VR2. When unit portions 11E of the same color (including white unit portions 11W) are disposed above and below each other in the layers VR1 and VR2, such color unit portions 11E in one of the upper and lower layers (in this exemplary embodiment, the upper layer VR2) are replaced with the transparent unit portions 11T formed of the transparent droplets 10T.

As a result, the three-dimensional object V has a portion in which the color unit portions 11E and the transparent unit portions 11T are alternately stacked.

For example, in the forming data in FIG. 3A, at positions 3A and 3B, both the upper and lower unit portions are the white unit portions 11W. At a position 3C, both the upper and lower unit portions are the magenta unit portions 11M, and at a position 3D, both the upper and lower unit portions are the support-material unit portions 11S.

Thus, as shown in the forming data in FIG. 3B, the white unit portions 11W, the magenta unit portion 11M, and the support-material unit portion 11S in the upper layer VR2 are replaced with the transparent unit portions 11T formed of the transparent droplets 10T.

When the discharge part 20 that forms a unit portion 11 in the upper layer VR2 is located upstream, in the scanning direction, of the discharge part 20 that forms a corresponding unit portion 11 in the lower layer VR2, the upper and lower unit portions are exchanged.

More specifically, when the forming part 110 is scanned in the +A direction, as shown in FIG. 3B, at a position 3E, the discharge part 20Y is located upstream of the discharge part 20W. Hence, as shown in FIG. 3C, the upper and lower unit portions are exchanged, so that the yellow unit portion 11Y is located in the lower layer VR1, and the white unit portion 11W is located in the upper layer VR2.

Furthermore, as shown in FIG. 3B, at a position 3F, the discharge part 20M is located upstream of the discharge part 20Y. Hence, as shown in FIG. 3C, the upper and lower unit portions are exchanged, so that the magenta unit portion 11M is located in the lower layer VR1, and the yellow unit portion 11Y is located in the upper layer VR2.

Furthermore, as shown in FIG. 3B, at a position 3D, the discharge part 20T is located upstream of the discharge part 20S. Hence, as shown in FIG. 3C, the upper and lower unit portions are exchanged, so that the transparent unit portion 11T is located in the lower layer VR1, and the support-material unit portion 11S is located in the upper layer VR2.

More specifically, although two layers VR1 and VR2 are formed in single scanning, it is impossible to discharge droplets 10 of the same color for the upper and lower layers. Hence, one of the upper and lower unit portions is replaced with a transparent unit portion 11T. Furthermore, because the discharge part 20 that forms a unit portion 11 in the lower layer VR1 needs to be located upstream, in the scanning direction, of the discharge part 20 that forms a corresponding unit portion 11 in the upper layer VR2, if the positional relationship therebetween is not like that, the colors of the upper and lower unit portions are exchanged.

### Effects

The effects of this exemplary embodiment will be described below.

Because two layers are formed in single scanning (scanning in the +A or −A direction), the speed of forming a three-dimensional object V is higher than that in the case where one layer is formed in single scanning.

Note that the color quality is hardly affected by replacing the color unit portions 11E with the transparent unit portions 11T.

Furthermore, even if the colors of the upper and lower unit portions are exchanged such that the discharge part 20 located on the upstream side in the scanning direction discharges the droplet 10 first, the color quality is hardly affected.

Because the support-material unit portions 11S are replaced with the transparent unit portions 11T, the removal of the support part becomes slightly difficult. However, the removal is possible. It is also possible to provide an additional discharge part 20S for the support material, so that the support-material unit portions 11S are not replaced with the transparent unit portions 11T.

### Modification

Next, a modification of this exemplary embodiment will be described.

### Forming Part

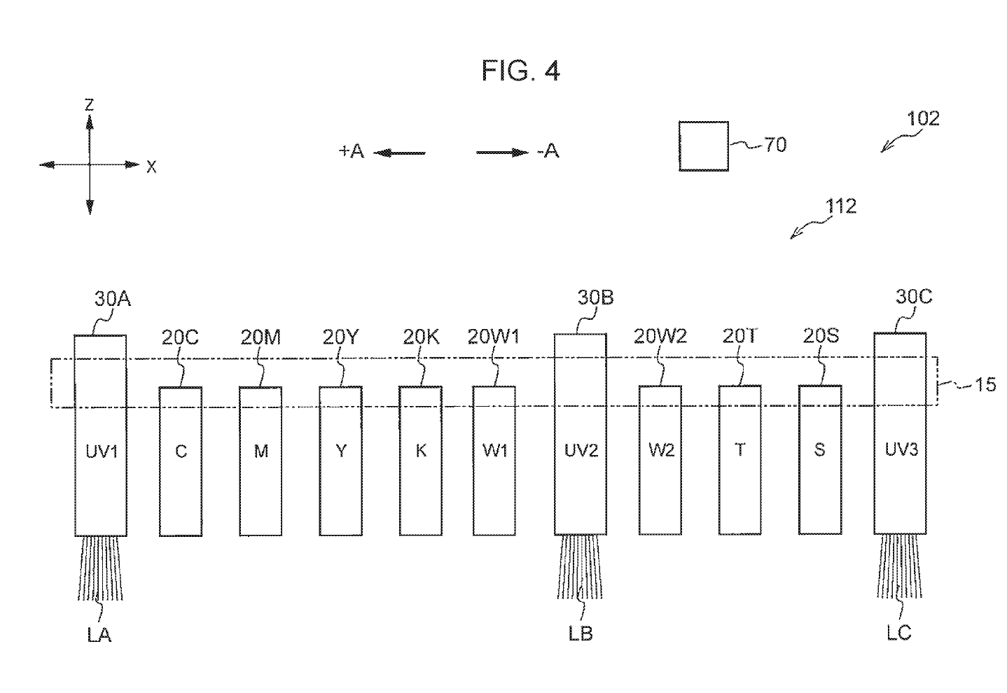

As shown in FIG. 4, a forming part 112 of a forming apparatus 102 according to this modification includes, in this order in the −A direction, a discharge part 20C, a discharge part 20M, a discharge part 20Y, a discharge part 20K, a discharge part 20W1, a discharge part 20W2, a discharge part 20T, and a discharge part 20S that discharge droplets of cyan (C), magenta (M), yellow (Y), black (K), first white (W1), second white (W2), transparent (T), and support-material (S) forming liquids, respectively, toward the base surface 50A of the stage part 50 (see FIG. 1).

The radiating part 30B is disposed between the discharge part 20W1 and the discharge part 20W2 in the X direction.

### Method for Forming Three-Dimensional Object

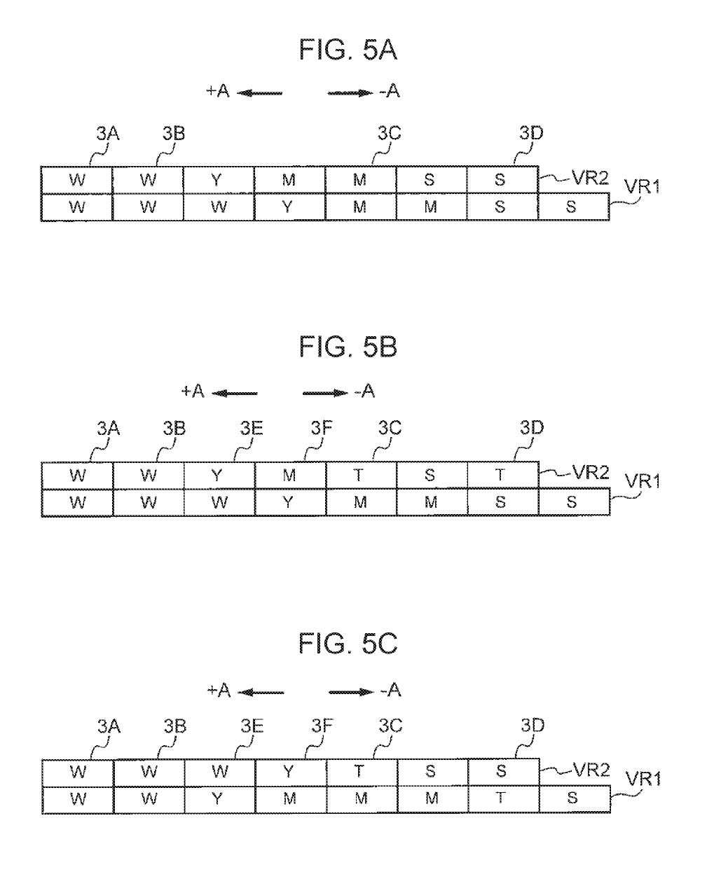

As shown in FIGS. 5A and 5B, the controller 70 divides data on the multiple layers VR into pairs of two layers. When unit portions 11E of the same color are disposed above and below each other in the layers VR1 and VR2, such color unit portions 11E in one of the upper and lower layers (in this exemplary embodiment, the upper layer VR2) are replaced with the transparent unit portions 11T formed of the transparent droplets 10T.

However, when both the upper and lower unit portions in the layers VR1 and VR2 are the white unit portions 11W, like positions 3A and 3B, they are not replaced with the transparent unit portions 11T.

As shown in FIG. 5C, when the discharge part 20 that forms a unit portion 11 in the upper layer VR2 is located upstream, in the scanning direction, of the discharge part 20 that forms a corresponding unit portion 11 in the lower layer VR2, the upper and lower unit portions are exchanged.

### Effects

The effects of this modification will be described below.

Because two layers are formed in single scanning (scanning in the +A or −A direction), the speed of forming a three-dimensional object V is higher than that in the case where one layer is formed in single scanning.

If the white unit portions 11W, which are pale-color unit portions, are replaced with the transparent unit portions 11T, the color quality may be decreased. However, in this modification, because the white unit portions 11W are not replaced with the transparent unit portions 11T, the color quality is higher than that in the case where the white unit portions 11W are replaced with the transparent unit portions 11T.

Furthermore, in this exemplary embodiment, the inside of the three-dimensional object V is formed of the white unit portions 11W and is be used as the base. Because the white unit portions 11W constituting the base are not replaced with the transparent unit portions 11T, the whiteness of the base is increased, and thus, the color quality at the outside of the three-dimensional object V is improved.

### Second Exemplary Embodiment

A forming apparatus according to a second exemplary embodiment of the present invention will be described. The same components as those in the first exemplary embodiment will be denoted by the same reference signs, and overlapping explanations will be omitted.

### Overall Configuration

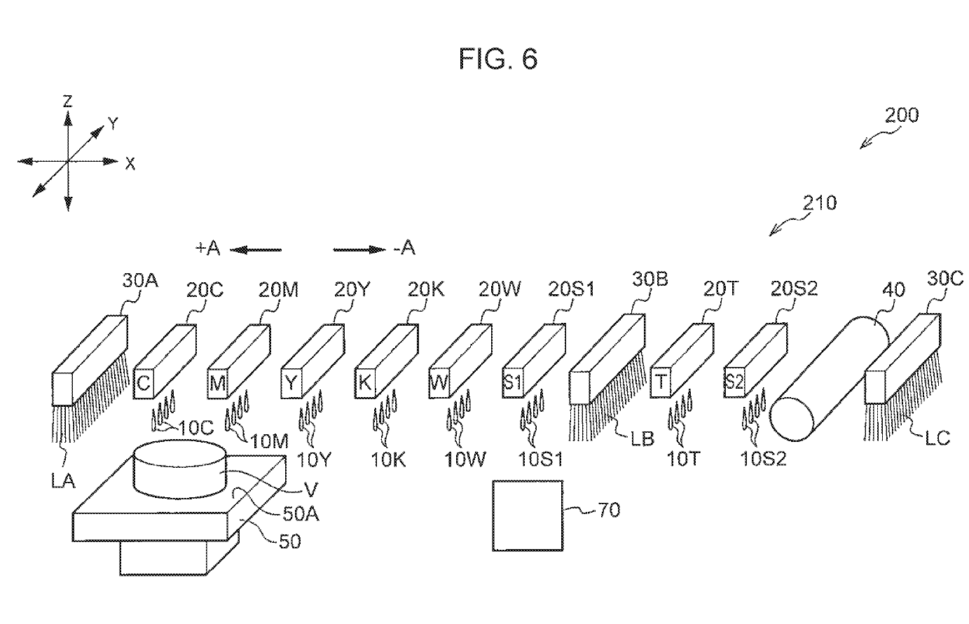

As shown in FIG. 6, a forming apparatus 200 according to this exemplary embodiment forms a color three-dimensional object V by discharging yellow (Y), magenta (M), cyan (C), black (K), and white (W) forming liquids.

### Forming Part

As shown in FIG. 6, the forming apparatus 200 includes a forming part 210, a stage part 50, a controller 70, and the like.

As shown in FIGS. 6 to 8, the forming part 210 includes, in this order in the −A direction, a discharge part 20C, a discharge part 20M, a discharge part 20Y, a discharge part 20K, a discharge part 20W, a discharge part 20S1, a discharge part 20T, and a discharge part 20S2 that discharge droplets 10C, 10M, 10Y, 10K, 10W, 1051, 10T, and 10S2 of cyan (C), magenta (M), yellow (Y), black (K), white (W), first support-material (S1), transparent (T), and second support-material (S2) forming liquids, respectively, toward the base surface 50A of the stage part 50 (see FIG. 6).

The forming part 210 further includes a radiating part 30A, a radiating part 30B, a radiating part 30C, and a flattening roller 40 (see FIG. 6).

The discharge parts 20C, 20M, 20Y, 20K, 20W, 20S1, 20T, and 20S2 are arranged at intervals in the X direction. The radiating part 30A and the radiating part 30C are disposed on the extreme outer sides in the X direction, and the radiating part 30B is disposed between the discharge part 20S1 and the discharge part 20T in the X direction. As shown in FIG. 6, the flattening roller 40 is provided between the discharge part 20S1 and the radiating part 30C in the X direction.

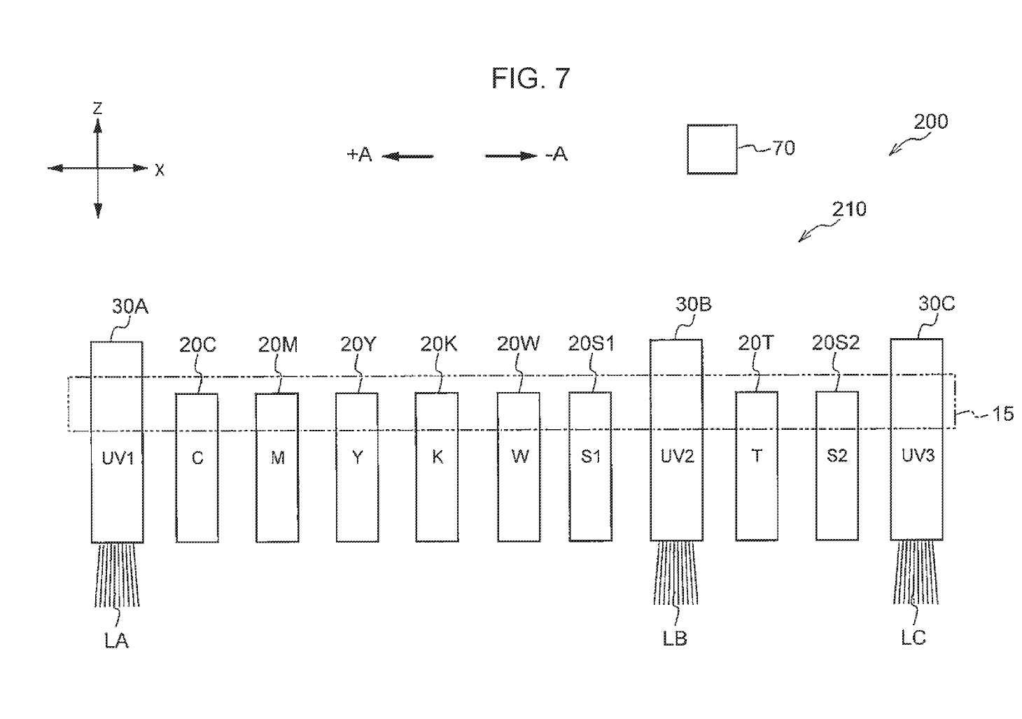

The discharge parts 20C, 20M, 20Y, 20K, 20W, 20S1, 20T, and 20S2, the radiating parts 30A, 30B, and 30C, and the flattening roller 40 (see FIG. 6) are integrally held by a retaining member 15 (see FIG. 7).

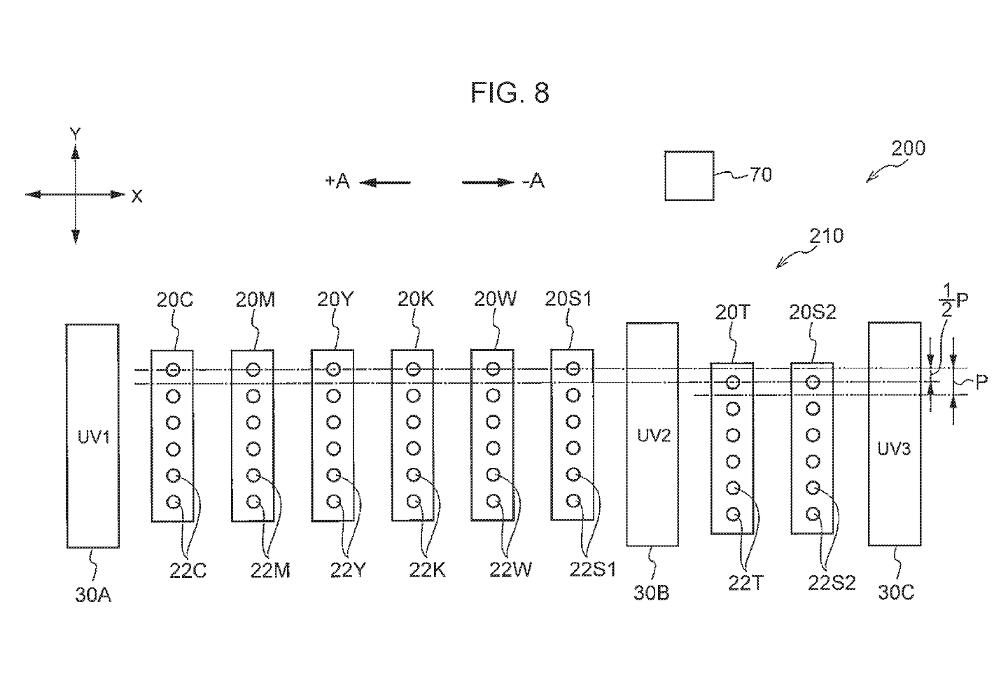

As shown in FIG. 8, the discharge parts 20 each have multiple nozzles 22 that discharge droplets and that are arrayed at a pitch P in the Y direction. The discharge parts 20T and 20S2 are shifted with respect to the discharge parts 20C, 20M, 20Y, 20K, 20W, and 20S1 by half a pitch P in the Y direction, i.e., the principal scanning direction. As will be described below, in this exemplary embodiment, the unit portions 11, each being composed of a single droplet 10, formed in a single discharge part 20 are arrayed at intervals of the pitch P in the Y direction, i.e., the principal scanning direction.

### Stage Part

The top surface of the stage part 50 serves as the base surface 50A, on which the three-dimensional object V is formed. The stage part 50 is moved in the Y and X directions relative to the forming part 210 and is also moved in the height direction of the forming apparatus (Z direction) by a moving mechanism (not shown).

### Method for Forming Three-Dimensional Object

Next, an example method for forming a three-dimensional object V with the forming apparatus 200 according to this exemplary embodiment will be described. First, the outline of the forming method will be described, and then, the detail of the forming method will be described.

The controller 70 causes the discharge parts 20 to discharge droplets 10 and causes the radiating parts 30 to radiate the radiation light L, while scanning the stage part 50 back and forth in the X direction relative to the forming part 210. After landing, the droplets 10 discharged from the discharge parts 20 are irradiated with the radiation light L emitted from the radiating parts 30 and are cured.

In the back-and-forth scanning, after the forming part 210 is scanned in the +A direction, which is the outgoing direction, the forming part 210 is moved by half a pitch in one direction in the Y direction, i.e., the principal scanning direction, and is then scanned in the −A direction, which is the returning direction. After the forming part 210 is scanned in the −A direction, the forming part 210 is moved in the other direction in the Y direction by half a pitch, thus returning to the original position, and the forming part 210 is scanned in the +A direction, which is the outgoing direction. This process is repeated.

In this exemplary embodiment, the unit portions 11, each being composed of a single droplet 10, formed in a single discharge part 20 are arrayed at intervals of the pitch P in the Y direction, i.e., the principal scanning direction. When the forming part 210 is scanned in the +A direction, the discharge parts 20C, 20M, 20Y, 20K, 20W, and 20S1 form even-number rows, and the discharge parts 20T and 20S2 form odd-number rows. When the forming part 210 is scanned in the −A direction, the discharge parts 20C, 20M, 20Y, 20K, 20W, and 20S1 form odd-number rows, and the discharge parts 20T and 20S2 form even-number rows.

Next, the forming method will be described in detail.

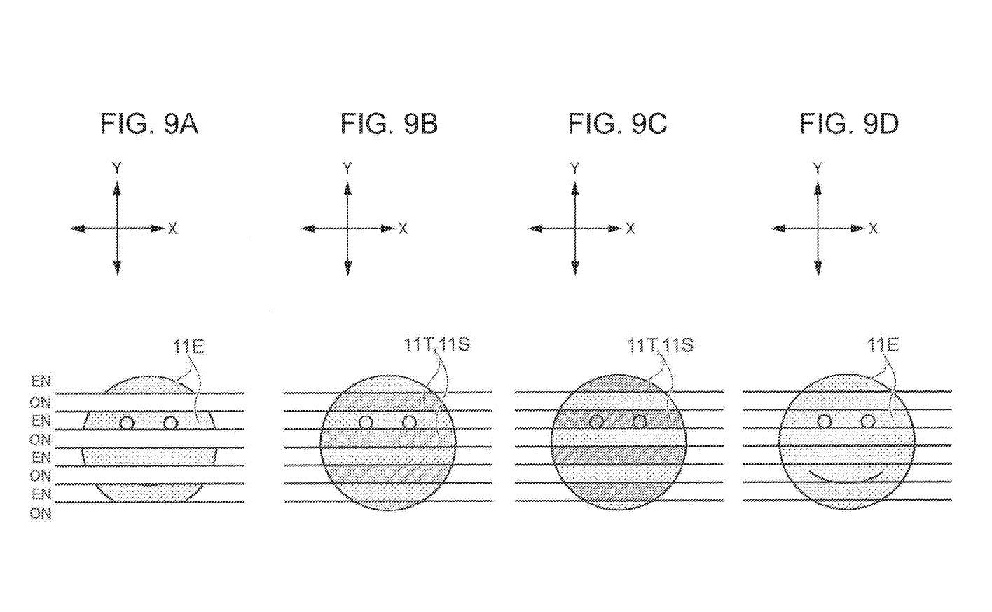

When the forming part 210 is scanned in the +A direction, which is the outgoing direction, as shown in FIG. 9A, the discharge parts 20C, 20M, 20Y, 20K, 20W, and 20S1 form the color unit portions 11E, including the support-material unit portions 11S1, on even-number rows EN, and, as shown in FIG. 9B, the discharge parts 20T and 20S2 form the transparent unit portions T or the support-material unit portions S2 on odd-number rows ON. Thus, the first layer, namely, the layer VR1, is formed. The support part is formed of the support-material unit portions S2, and the other portions are formed of the transparent unit portions T.

When the forming part 210 is moved by half a pitch in one direction in the Y direction and is then scanned in the −A direction, which is the returning direction, as shown in FIG. 9C, the discharge parts 20T and 20S2 form the transparent unit portions T or the support-material unit portions S2 in the even-number rows EN, on the layer VR1. At this time, the transparent unit portions T or the support-material unit portions S2 are formed on the color unit portions 11E. Similarly, the support part is formed of the support-material unit portions S2, and the other portions are formed of the transparent unit portions T.

Furthermore, as shown in FIG. 9D, the discharge parts 20C, 20M, 20Y, 20K, 20W, and 2051 form the color unit portions 11E on the odd-number rows ON. At this time, the color unit portions 11E are formed on the transparent unit portions T or the support-material unit portions S2.

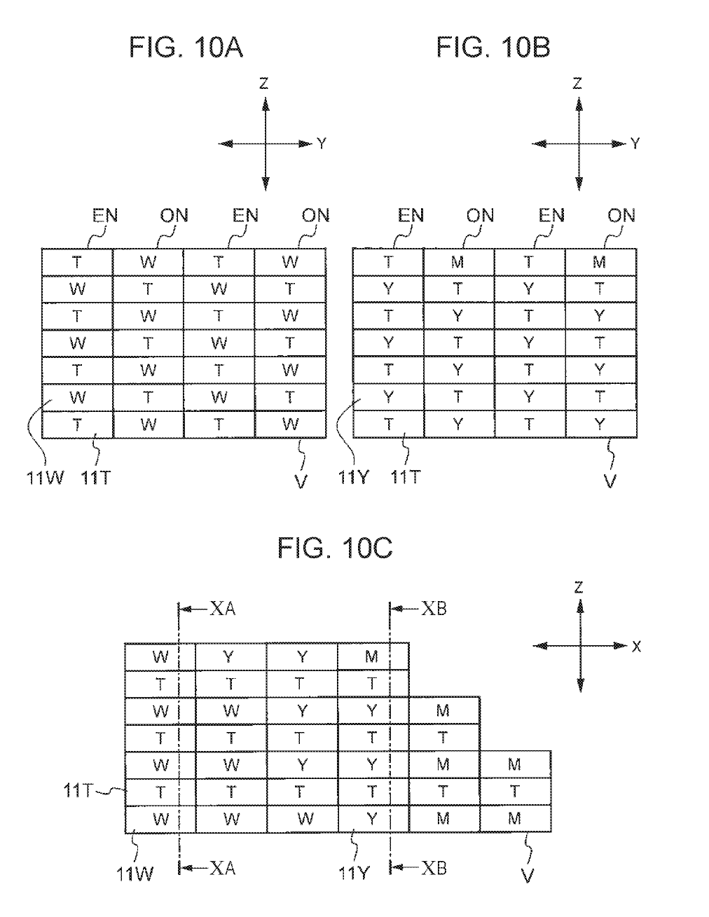

An example of the thus-formed three-dimensional object V is shown in FIGS. 10A to 10C. FIG. 10C is a schematic sectional view of a three-dimensional object V taken in the Y direction. FIG. 10A is a schematic sectional view taken along line XA-XA in FIG. 10C, and FIG. 10B is a schematic sectional view taken along line XB-XB in FIG. 10C.

The thus-formed three-dimensional object V has a portion in which the color unit portions 11E, including the white unit portions and the support material unit portions, and transparent unit portions 11T are alternately stacked, as shown in FIGS. 10A to 10C, and has a portion in which the color unit portions 11E and the transparent unit portions 11T are alternately arrayed in the Y direction, i.e., the principal scanning direction, as shown in FIGS. 10A and 10B. In other words, the three-dimensional object V has a portion in which the color unit portions 11E and the transparent unit portions 11T are arranged in a checkerboard pattern.

### Effects

The effects of this exemplary embodiment will be described below.

First, a forming apparatus 900 according to a comparative example to which the present invention is not applied will be described.

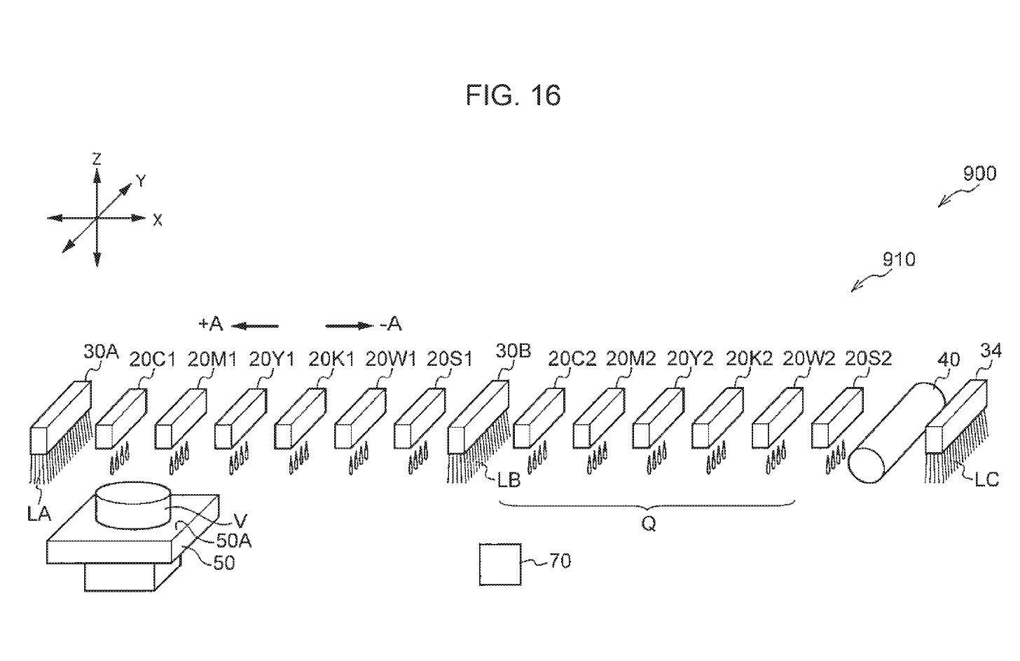

As shown in FIG. 16, a forming part 910 of a forming apparatus 900 according to the comparative example includes discharge parts 20C2, 20M2, 20Y2, 20K2, and 20W2 (see a part Q in FIG. 16), instead of the discharge parts 20T (FIG. 6) of the forming part 210 according to this exemplary embodiment.

Whereas the forming apparatus 900 according to the comparative example has twelve discharge parts 20 in total, the forming apparatus 200 according to this exemplary embodiment has, as shown in FIG. 6, eight discharge parts 20 in total, which is four less than twelve.

In other words, in the forming apparatus 200 according to this exemplary embodiment, which is shown in FIG. 6, the color unit portions 11E that are formed with the discharge parts 20C2, 20M2, 20Y2, 20K2, and 20W2 of the forming apparatus 900 according to the comparative example, which is shown in FIG. 16, are replaced with the transparent unit portions 11T that are formed with the discharge part 20T.

Furthermore, the length, in the X direction, which is the sub-scanning direction, of the forming part 210 according to this exemplary embodiment, which is shown in FIG. 6, is smaller than that of the forming part 910 according to the comparative example, which is shown in FIG. 16, because the forming part 210 has less discharge parts 20 than the forming part 910. Hence, the distance of travel in single scanning (scanning in the +A or −A direction) is smaller, and thus, the speed of forming a three-dimensional object V is higher than that in the comparative example.

Thus, the forming apparatus 200 according to this exemplary embodiment forms a three-dimensional object V at a higher speed than the forming apparatus 900 according to the comparative example, with less discharge parts 20.

It is also possible that the discharge part 20S2 for the second support material S2 is not provided and that the support-material unit portions 11S2 are replaced with the transparent unit portions 11T that are formed with the transparent discharge part 20T. In this case, because the support-material unit portions 11S2 are replaced with the transparent unit portions 11T, the removal of the support part becomes slightly difficult. However, the removal is possible.

### Modification

Next, a modification of this exemplary embodiment will be described.

### Forming Part

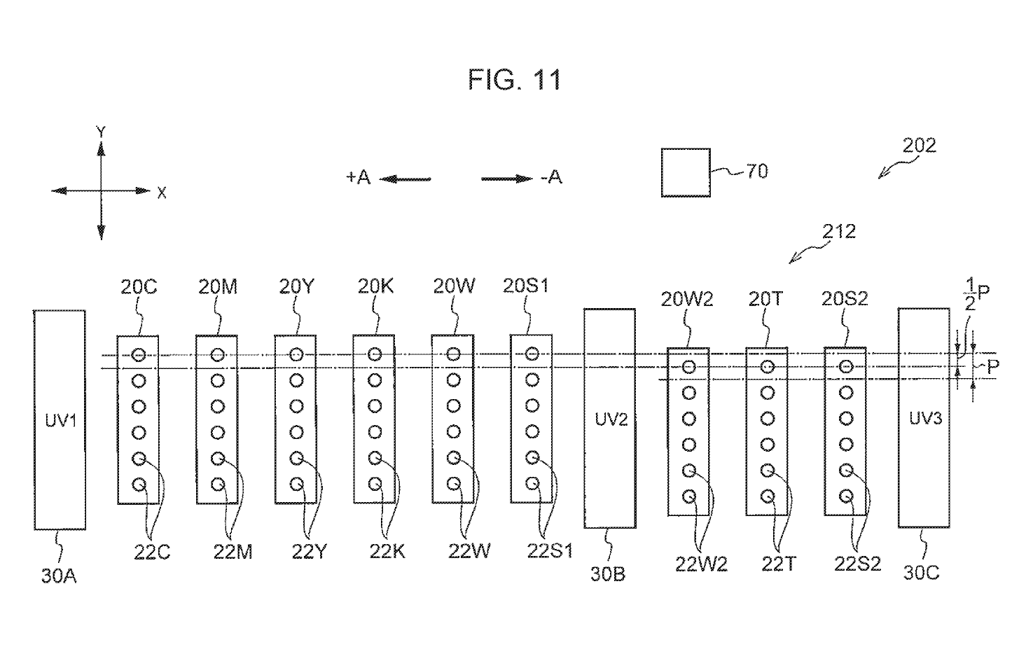

As shown in FIG. 11, a forming part 212 of a forming apparatus 202 according to this modification includes, in this order in the −A direction, a discharge part 20C, a discharge part 20M, a discharge part 20Y, a discharge part 20K, a discharge part 20W1, a discharge part 20S1, a discharge part 20W2, a discharge part 20T, and a discharge part 20S2 that discharge droplets of cyan (C), magenta (M), yellow (Y), black (K), first white (W1), first support-material (S1), second white (W2), transparent (T), and second support-material (S2) forming liquids, respectively, toward the base surface 50A of the stage part 50 (see FIG. 6).

The radiating part 30B is disposed between the discharge part 20S1 and the discharge part 20W2.

The discharge part 20W2, the discharge part 20T, and the discharge part 20S2 are shifted with respect to the discharge parts 20C, 20M, 20Y, 20K, 20W1, and 20S1 by half a pitch in the Y direction, i.e., the principal scanning direction.

### Method for Forming Three-Dimensional Object

When the forming part 212 is scanned in the +A direction, which is the outgoing direction, the discharge parts 20C, 20M, 20Y, 20K, 20W1, and 20S1 form even-number rows EN (see FIG. 9), and the discharge parts 20W2, 20T, and 20S2 form odd-number rows ON (see FIG. 9).

When the forming part 210 is moved by half a pitch in one direction in the Y direction and is then scanned in the −A direction, which is the returning direction, the discharge parts 20W2, 20T, and 20S2 form even-number rows EN (see FIG. 9), and the discharge parts 20C, 20M, 20Y, 20K, 20W1, and 20S1 form odd-number rows ON.

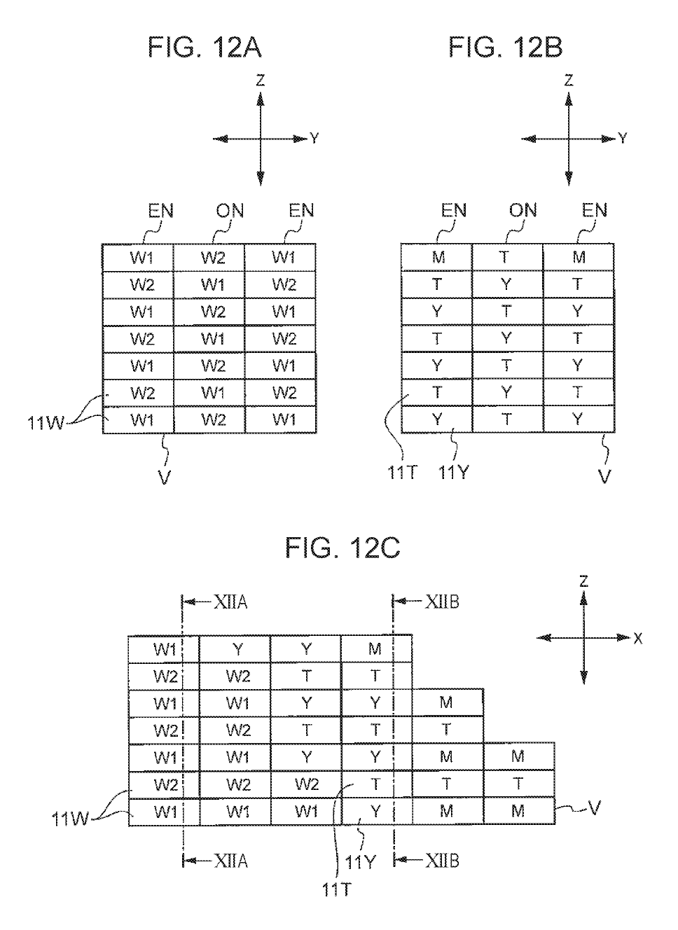

An example of the thus-formed three-dimensional object V is shown in FIGS. 12A to 12C. FIG. 12C is a schematic view of the three-dimensional object V, as viewed in the Y direction. FIG. 12A is a schematic sectional view taken along line XIIA-XIIA in FIG. 12C, and FIG. 12B is a schematic sectional view taken along line XIIB-XIIB in FIG. 100.

The thus-formed three-dimensional object V has a portion in which the color unit portions 11E, excluding the white unit portions and including the support material unit portions, and the transparent unit portions 11T are alternately stacked, as shown in FIGS. 12A to 12C, and has a portion in which the color unit portions 11E and the transparent unit portions 11T are alternately arrayed in the Y direction, as shown in FIGS. 12A and 12B. In other words, the three-dimensional object V has a portion in which the color unit portions 11E and the transparent unit portions 11T are arranged in a checkerboard pattern.

### Effects

The effects of this modification will be described below.

If the white unit portions 11W, which are pale-color unit portions, are replaced with the transparent unit portions 11T, the color quality may be decreased. However, in this modification, because the white unit portions 11W are not replaced with the transparent unit portions 11T, the color quality is higher than that in the case where the white unit portions 11W are replaced with the transparent unit portions 11T.

Furthermore, in this exemplary embodiment, the inside of the three-dimensional object V is formed of the white unit portions 11W and is be used as the base. Because the white unit portions 11W constituting the base are not replaced with the transparent unit portions 11T, the whiteness of the base is increased, and thus, the color quality at the outside of the three-dimensional object V is improved.

### Third Exemplary Embodiment

A forming apparatus according to a third exemplary embodiment of the present invention will be described. The same components as those in the first and second exemplary embodiments will be denoted by the same reference signs, and overlapping explanations will be omitted.

### Overall Configuration

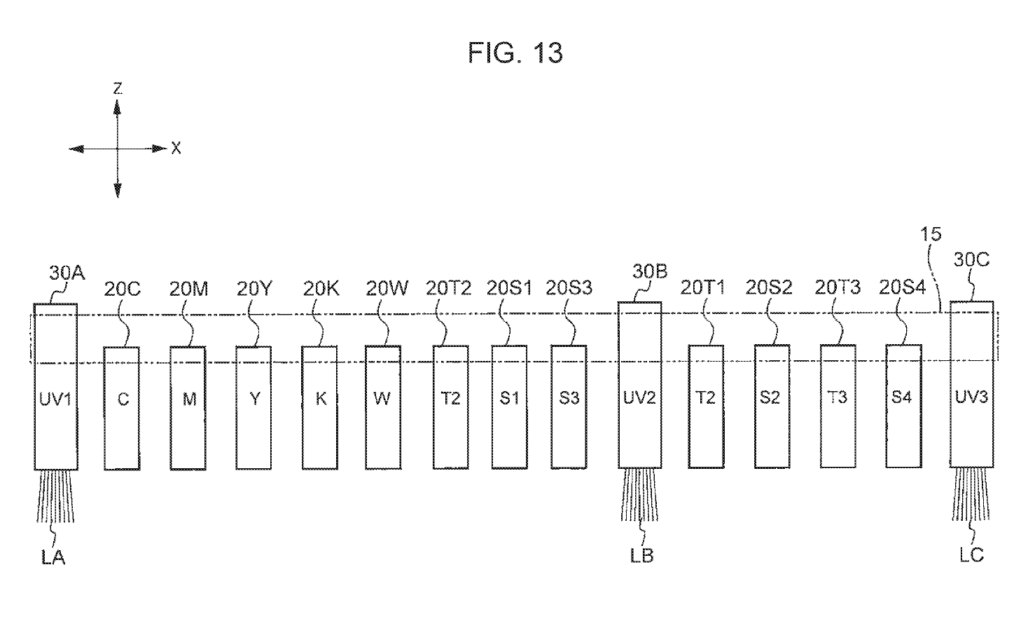

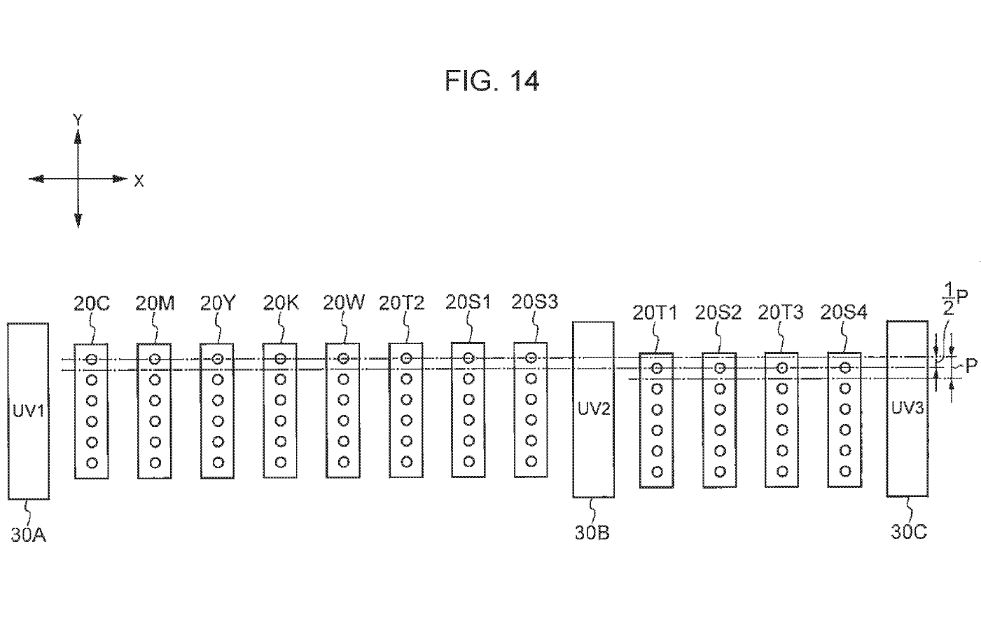

As shown in FIGS. 13 and 14, a forming apparatus 300 according to this exemplary embodiment forms a color three-dimensional object V (see FIGS. 1 and 6) by discharging yellow (Y), magenta (M), cyan (C), black (K), and white (W) forming liquids.

### Forming Part

The forming apparatus 300 includes a forming part 310, a stage part 50 (see FIGS. 1 and 6), a controller 70, and the like.

The forming part 310 includes, in addition to the discharge parts of the forming part 210 according to the second exemplary embodiment (see FIGS. 7 and 8), a discharge part 20T2, a discharge part 20S3, a discharge part 20T3, and a discharge part 20S4 that discharge droplets of second transparent (T2), third support-material (S3), third transparent (T3), and fourth support-material (S4) forming liquids toward the base surface 50A of the stage part 50 (see FIG. 6). The discharge part 20C, the discharge part 20M, the discharge part 20Y, the discharge part 20K, the discharge part 20W, the discharge part 20T2, the discharge part 20S1, the discharge part S3, the discharge part 20T1, the discharge part 20S2, the discharge part 20T3, and the discharge part 20S2 are arranged in this order in the −A direction.

The forming part 310 includes a radiating part 30A, a radiating part 30B, a radiating part 30C, and a flattening roller 40 (see FIG. 6).

The radiating part 30A and the radiating part 30C are disposed on the extreme outer sides in the X direction, and the radiating part 30B is disposed between the discharge part 20S3 and the discharge part 20T1. The flattening roller 40 (not shown) is provided between the discharge part 20S4 and the radiating part 30C.

As shown in FIG. 14, the discharge parts 20 each have multiple nozzles 22 that discharge droplets and that are arrayed at a pitch P in the Y direction.

The discharge part 20T1, the discharge part 20S2, the discharge part 20T3, and the discharge part 20S4 are shifted with respect to the discharge part 20C, the discharge part 20M, the discharge part 20Y, the discharge part 20K, the discharge part 20W, the discharge part 20T2, the discharge part 20S1, and the discharge part 20S3 by half a pitch in the Y direction, i.e., the principal scanning direction.

### Method for Forming Three-Dimensional Object

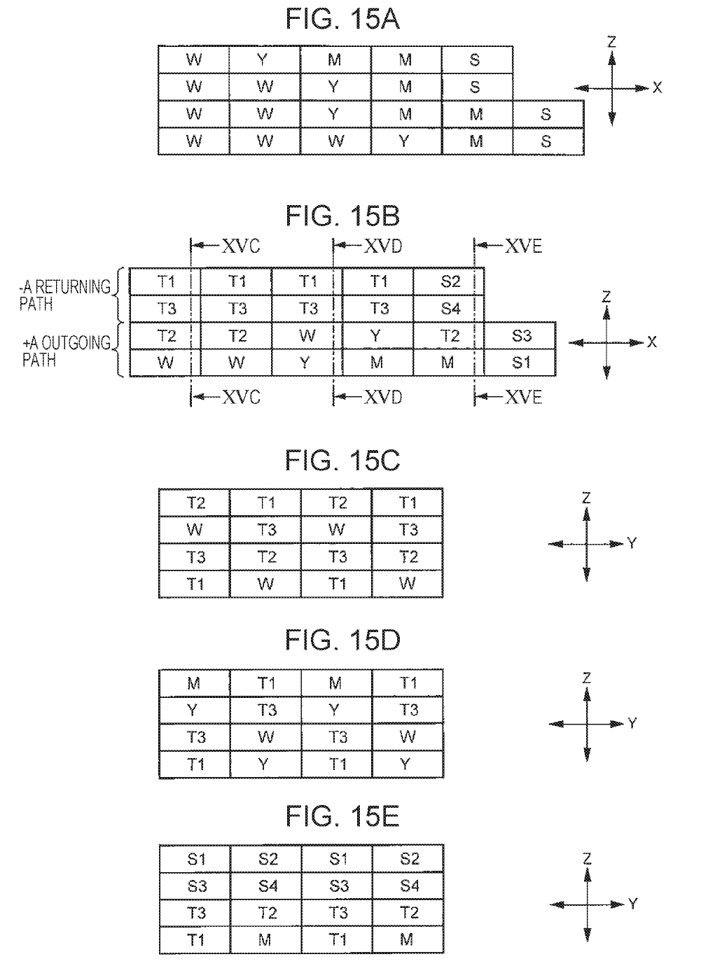

Next, a forming method will be described with reference to FIG. 15.

When the forming part 212 is scanned in the +A direction, which is the outgoing direction, the discharge part 20C, the discharge part 20M, the discharge part 20Y, the discharge part 20K, the discharge part 20W, the discharge part 20T2, the discharge part 20S1, and the discharge part 20S3 form even-number rows EN (see FIG. 9), and the discharge part 20T1, the discharge part 20S2, the discharge part 20T3, and the discharge part 20S4 form odd-number rows ON (see FIG. 9).

After the forming part 310 is scanned in the +A direction, the forming part 310 is moved by half a pitch in one direction in the Y direction and is then scanned in the −A direction, which is the returning direction. At this time, the discharge part 20C, the discharge part 20M, the discharge part 20Y, the discharge part 20K, the discharge part 20W, the discharge part 20T2, the discharge part 20S1, and the discharge part 20S3 form odd-number rows ON (see FIG. 9) and the discharge part 20T1, the discharge part 20S2, the discharge part 20T3, and the discharge part 20S4 form even-number rows EN (see FIG. 9).

In each scanning (scanning in the +A or −A direction), as that in the first exemplary embodiment, two layers are formed. Hence, when unit portions 11E of the same color are disposed above and below each other in the upper and lower layers VR1 and VR2, such color unit portions 11E in one of the upper and lower layers (in this exemplary embodiment, the upper layer VR2) are replaced with the transparent unit portions 11T formed of the transparent droplets 10T.

When the discharge part 20 that forms a unit portion 11 in the upper layer VR2 is located upstream, in the scanning direction, of the discharge part 20 that forms a corresponding unit portion 11 in the lower layer VR2, the upper and lower unit portions are exchanged.

More specifically, although two layers VR1 and VR2 are formed in single scanning, it is impossible to discharge droplets 10 of the same color for the upper and lower layers. Hence, one of the upper and lower unit portions is replaced with a transparent unit portion 11T. Furthermore, because the discharge part 20 that forms a unit portion 11 in the lower layer VR1 needs to be located upstream, in the scanning direction, of the discharge part 20 that forms a corresponding unit portion 11 in the upper layer VR2, if the positional relationship therebetween is not like that, the colors of the upper and lower unit portions are exchanged.

### Effects

The effects of this modification will be described below.

Because two layers are formed in single scanning (scanning in the +A or −A direction), and thus, four layers are formed in back-and-forth scanning, the speed of forming a three-dimensional object V is higher than that in the case where one layer is formed in single scanning, and thus, two layers are formed in back-and-forth scanning.

It is also possible not to provide at least one of the discharge part 20S2 for the second support material S2, the discharge part 20S3 for the third support material S3, and the discharge part 20S4 for the fourth support material S4 and to replace the support-material unit portions 11S with the transparent unit portions 11T. Because the support-material unit portions 11S are replaced with the transparent unit portions 11T, the removal of the support part becomes slightly difficult. However, the removal is possible.

### Other Configurations

In the above-described exemplary embodiments, the resolution may be decreased due to landing interference of droplets. However, in the above-described exemplary embodiment, three radiating parts 30 are provided so that the droplets are cured quickly after landing. Thus, the landing interference is suppressed, and resolution decrease is suppressed. The number of the radiating parts 30 and the arrangement thereof may be selected, as appropriate, depending on the level of resolution decrease due to the landing interference, the cost, or other factors.

In the above-described exemplary embodiment, because the color unit portions 11E are replaced with the transparent unit portions 11T, the color intensities are slightly reduced. However, it does not greatly affect the color quality. The color intensity of the color unit portions 11E (droplets 10E) may be increased, compared with a case where the color unit portions 11E are not replaced with the transparent unit portions 11T.

Furthermore, the three-dimensional object V may have a portion in which the color unit portions 11E and the transparent unit portions 11T are periodically stacked or periodically arrayed in the principal scanning direction (for example, see FIG. 15), besides a portion in which the color unit portions 11E and the transparent unit portions 11T are alternately stacked or alternately arrayed in the principal scanning direction.

The exemplary embodiments of the present invention are not limited to those described above.

In the above-described modifications of the exemplary embodiments, multiple white discharge parts 20W are provided so that the white unit portions 11W are not replaced with the transparent unit portions 11T. However, multiple discharge parts 20 of another color may be provided so that the unit portions 11 of that color are not replaced with the transparent unit portions 11T.

The present invention may of course be implemented in various ways, without departing from the scope thereof.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A forming apparatus comprising:
a plurality of color discharge parts that discharge droplets of color forming liquids from nozzles arrayed in a principal scanning direction, the droplets constituting color unit portions when cured; and
a transparent discharge part that is provided at a side of the color discharge parts in a sub-scanning direction and that discharges droplets of a transparent forming liquid from nozzles arrayed in the principal scanning direction, the droplets constituting transparent unit portions when cured,
wherein a three-dimensional object is formed so as to have a portion in which the color unit portions and the transparent unit portions are periodically stacked.

2. A forming apparatus comprising:
a plurality of color discharge parts that discharge droplets of color forming liquids from nozzles arrayed in a principal scanning direction, the droplets constituting color unit portions when cured; and
a transparent discharge part that is provided at a side of the color discharge parts in a sub-scanning direction and that discharges droplets of a transparent forming liquid from nozzles arrayed in the principal scanning direction, the droplets constituting transparent unit portions when cured, wherein
the color discharge parts and the transparent discharge part discharge droplets so as to form two layers in single scanning in the sub-scanning direction, and
a three-dimensional object is formed such that one of unit portions having the same color in the two layers on forming data is replaced with a transparent unit portion.

3. The forming apparatus according to claim 2, wherein
the plurality of color discharge parts include two or more specific-color discharge parts corresponding to predetermined specific colors, and
the three-dimensional object is formed such that, for these specific colors, one of unit portions having the same color in the two layers is not replaced with a transparent unit portion.

4. The forming apparatus according to claim 1, wherein the three-dimensional object is formed so as to have a portion in which the color unit portions and the transparent unit portions are alternately arrayed in the principal scanning direction.

5. The forming apparatus according to claim 4, wherein
the plurality of color discharge parts include two or more specific-color discharge parts corresponding to predetermined specific colors, and
the three-dimensional object is formed so as to have a portion in which specific-color unit portions are arrayed in the principal scanning direction.

6. A forming apparatus comprising:
a plurality of color discharge parts that discharge droplets of color forming liquids from nozzles arrayed in a principal scanning direction, the droplets constituting color unit portions when cured; and
a transparent discharge part that is provided at a side of the color discharge parts in a sub-scanning direction and that discharges droplets of a transparent forming liquid from nozzles arrayed in the principal scanning direction, the droplets constituting transparent unit portions when cured,
wherein a three-dimensional object is formed so as to have a portion in which the color unit portions and the transparent unit portions are periodically arrayed in the principal scanning direction.

7. The forming apparatus according to claim 1, further comprising a flattening part that flattens the three-dimensional object.

8. A forming apparatus comprising:
a plurality of color discharge parts in which a plurality of nozzles for discharging droplets of color forming liquids are arranged at a predetermined pitch in a principal scanning direction;
a transparent discharge part in which a plurality of nozzles for discharging droplets of a transparent forming liquid are arranged at the predetermined pitch, the transparent discharge part being provided at a side of the color discharge parts in a sub-scanning direction such that the nozzles thereof are shifted with respect to the nozzles of the color discharge parts by half a pitch in the principal scanning direction;
a retaining part that retains the color discharge parts and the transparent discharge part; and
a controller that scans the retaining part back and forth in the sub-scanning direction relative to a stage part and that moves the retaining part back and forth by half a pitch in the principal scanning direction to form a three-dimensional object on the stage part.

9. The forming apparatus according to claim 8, wherein
the plurality of color discharge parts include two or more specific-color discharge parts corresponding to predetermined specific colors, and
nozzles of at least one of the specific-color discharge parts are shifted with respect to the nozzles of the other color discharge parts by half a pitch in the principal scanning direction.

10. The forming apparatus according to claim 8, wherein the transparent discharge part includes two or more transparent discharge parts, at least one of the transparent discharge parts being shifted with respect to the color discharge parts by half a pitch in the principal scanning direction.

11. The forming apparatus according to claim 7, further comprising a flattening part that flattens the three-dimensional object.
